(19) United States
(12) Patent Application Publication
(10) Pub. No.: US 2014/0236838 A1
(43) Pub. Date: Aug. 21, 2014

(54) ACCOUNT ACCESS AT POINT OF SALE

(71) Applicants: Syed Fayez Asar, San Jose, CA (US); Peter Chu, San Jose, CA (US); Attaullah Baig, San Jose, CA (US); West Stringfellow, San Jose, CA (US); Pravir Ramtekkar, San Jose, CA (US); Ansar Ansari, San Jose, CA (US)

(72) Inventors: Syed Fayez Asar, San Jose, CA (US); Peter Chu, San Jose, CA (US); Attaullah Baig, San Jose, CA (US); West Stringfellow, San Jose, CA (US); Pravir Ramtekkar, San Jose, CA (US); Ansar Ansari, San Jose, CA (US)

(21) Appl. No.: 14/236,310

(22) PCT Filed: Aug. 3, 2012
(86) PCT No.: PCT/US12/49597

§ 371 Date: Apr. 28, 2014

Related U.S. Application Data
(60) Provisional application No. 61/514,601, filed on Aug. 3, 2011.
(60) Provisional application No. 61/567,013, filed on Feb. 10, 2012.

(51) Int. Cl. G06Q 20/40; G06Q 20/20

(52) U.S. Cl. CPC G06Q 20/4012; G06Q 20/20
USPC 705/71; 705/72

(57) ABSTRACT

A user makes a payment at a POS by entering the user's phone number (either through a keypad or via a card swipe) and PIN into a POS device (such as through a keypad). That information is communicated to a payment provider, who can then access the user's account, determine whether to approve or deny the payment, and notify the merchant of the decision.

### CROSS REFERENCE TO RELATED APPLICATIONS

This application claims priority to U.S. Patent Application Ser. Nos. 61/514,601, filed Aug. 3, 2011, and 61/567,013, filed Feb. 10, 2012 which are incorporated herein by reference as part of the present disclosure.

### BACKGROUND

1. Field of the Invention

The present invention generally relates to financial transactions, and in particular, to payment authorizations.

2. Related Art

In a typical financial transaction at a point of sale (POS), the consumer, user, or payer presents a funding instrument to a merchant/agent for payment of goods or services. One common funding instrument is a card, such as a credit card or a debit card, having a magnetic stripe. The user swipes the card through a reader at the POS, which then communicates the card information and transaction information for processing, such as with a credit provider. The merchant is then notified whether the payment is approved or denied.

However, this requires the user to have the payment instrument physically present and requires the user to retrieve the funding instrument and swipe. If the card or magnetic stripe is damaged, the card may not be able to be processed through the POS device, thereby requiring the merchant to manually enter the card information. Carrying a card may be inconvenient for the user, the card may be lost or stolen, and/or the user may forget the card or wallet. Such situations would make payment difficult or impossible.

Therefore, a need exists to provide an easier way to make a payment at a POS without requiring the user to present a physical funding instrument.

### BRIEF DESCRIPTION OF THE FIGURES

FIG. 1A is a flowchart showing a process for setting up a phone plus PIN payment according to one embodiment;

FIG. 1B is a flowchart showing a process for using a phone plus PIN payment at a merchant POS according to one embodiment;

FIG. 2 is a block diagram of a networked system suitable for implementing the process of FIGS. 1A and 1B according to an embodiment; and

FIG. 3 is a block diagram of a computer system suitable for implementing one or more components in FIG. 2 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a user makes a payment at a POS by entering the user's phone number and PIN into a POS device, such as through a keypad. That information is communicated to a payment provider (in a secure manner), who can then access the user's account, determine whether to approve or deny the payment, and notify the merchant of the decision.

In one embodiment, the user first registers their phone number and PIN/password with the payment provider. The phone number can be a mobile number. The PIN can be a sequence of numbers, which may have a minimum and/or maximum length. The user may also set certain conditions for using this service at a POS, including a specific funding source and limits on transactions and transaction amounts.

Once set up, the user enters the phone number and PIN at a retailer POS, such as through a keypad or pin pad. This can be during or at the beginning or end of a checkout or payment process. The PIN is encrypted and sent to the payment provider, who uses the entered information to access the user's account. The payment provider also receives transaction details from the merchant, such as total amount of the purchase. Using the received information, a determination is made whether to approve the payment. If approved, the merchant is notified, and the payment is completed. The user may also be notified of a successful payment, such as through the user's mobile device.

As a result, the user is able to quickly and easily make a payment at a POS without having to present or swipe a payment instrument to the merchant.

In one embodiment, the user has a card issued by the payment provider, such as a card with a magnet stripe. The user may swipe the card at the POS to authenticate the user and obtain access to the user's account. In this embodiment, the card swipe is equivalent in terms of result to the phone number plus PIN. In other words, the card swipe can be an identity token to authenticate the user. In another embodiment, one-time-password (OTP) functionality can be used as an authentication token. The OTP functionality can be used at the point of sale in lieu of card if the card is not present. The OTP can be expressed through a bar-code, QR-code or transmitted via NFC (via P2P).

In another embodiment, the user enters the PIN after the card is swiped. In this embodiment, the card includes a user account identifier, but still requires the user to enter a PIN to use the account associated with the card.

The card, in one embodiment, may have a visible serial number that is used by the user to activate the card. The card number, which is contained in the magnetic stripe, is then linked to the user account with the payment provider once the card is activated. Thus, the card does not contain a visual card number, as with conventional payment cards.

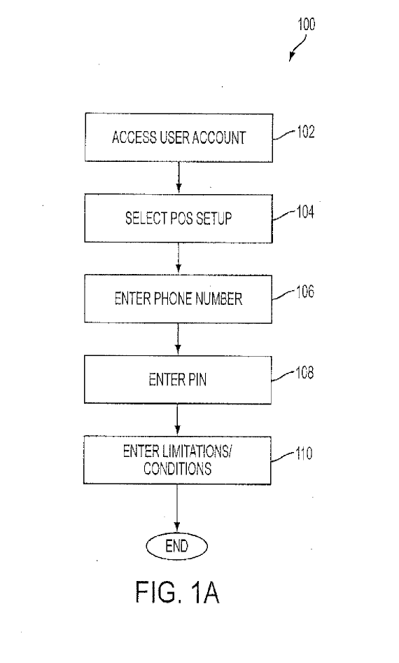

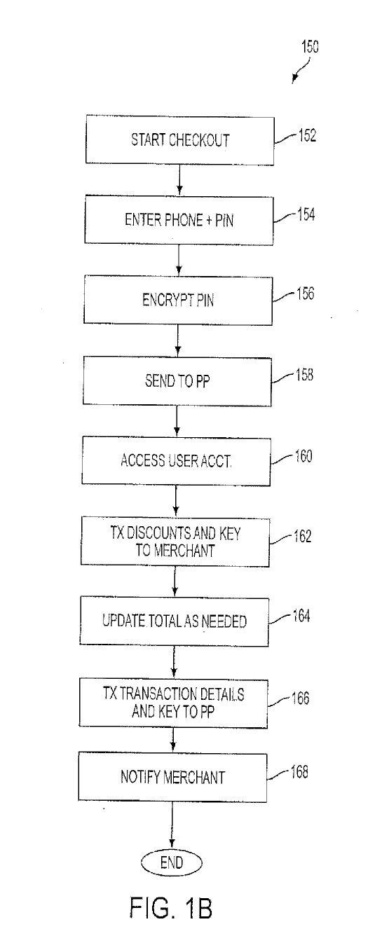

FIG. 1A is a flowchart showing a process 100 for setting up a phone plus PIN (personal identification number) payment according to one embodiment. At step 102, a user accesses the user's account with a payment provider, such as PayPal, Inc. of San Jose, Calif. This can be through a computing device, such as a PC, tablet, or phone. Access may include entering a user identifier, such as an email, phone number, or user name, and a password or PIN, through an app or website of the payment provider. If the user does not have an account, the user may create an account by providing the requested information to the payment provider.

Once the user has accessed the user's account, the user selects, at step 104, to sign up or use a phone number-plus-PIN payment service. For example, the user may select a link, tab, or button on the user's home page that indicates the desire to set up this payment option.

Upon request, the user may enter a phone number at step 106. The phone number may be associated with the user's mobile device. Typically, the user enters an area code and seven digit number or other phone number format for a specific country. However, the user may also be asked to enter a country code. Note that in another embodiment, a different identifier may be used, including the user's home number, the user's work number, another phone number, a sequence of numbers, or a sequence of letters, characters, symbols, and/or numbers. Once entered, the payment provider determines whether the number can be uniquely associated with the user or the user account. If not, the user may be requested to enter a different number. Two or more different numbers may be associated with the same master account. For example, an account may be used by a parent and a child, both of which have access, but different login credentials.

After the phone number is accepted, the user, upon request, enters a PIN at step 108. The user may be requested to enter the PIN based on specific restrictions. In one embodiment, the PIN is a sequence of numbers only, with a minimum and a maximum length (e.g., a PIN between 4 and 8 numbers). In another embodiment, the PIN or password is a sequence of characters, numbers, letters, symbols, or a combination thereof of two or more types. The payment provider may determine whether the entered PIN satisfies any stated or internal conditions, such as whether the PIN is unique or secure enough, based on internal rules. If the PIN is not acceptable, the user may be asked to enter a different PIN. If the PIN is acceptable, the user may be asked to reenter the PIN for confirmation.

Next, at step 110, the user may enter or select specific conditions or limitations for using the phone number-plus-PIN payment option. Note that this step may be optional if the payment provider does not allow the user to set conditions or limitations or if the user wishes to just user default conditions set by the payment provider. For the latter, the user may be presented with these conditions, which the user can elect to change or accept.

If the user wishes to change the conditions or wishes to set up conditions, the user selects or enters desired conditions. Examples of conditions include a maximum payment allowed per transaction, a maximum total dollar amount allowed per period (such as a day, a week, a month, etc.), maximum payments during certain times of the day or week, prohibited payment times or days, restrictions or limitations based on location of the transaction, a maximum number of transactions within a certain period, etc. The user may also designate a primary funding source for this payment option. The user may also designate different funding sources, based on different transaction details. For example, funding source A may be used with transactions over a certain amount, while funding source B is used for transactions under that certain amount. Also, funding source C may be used at one or more specific merchants, while funding source A may be used at a different one or more merchants. These conditions may be changed, such as through the user's account home page.

In another embodiment, the user may be provided a physical card for making in-store purchases. The physical card may be a plastic card with a visible serial number and a magnetic stripe encoded with a card number. The serial number, which can be a 13-16 digit number, is used to activate and link the card to the user account, while the magnetic stripe is used to identify a user account. In one embodiment, the card number is a 16 digit number and has a one-to-one correspondence with the visible serial number on the card. Note that the card number is not visible, which is contrary to conventional payment cards. The card may also have an expiration date printed thereon and/or encoded on the magnetic stripe. Also, in one embodiment, the card does not have a security code (or CVV2) number printed or encoded thereon.

In one embodiment, the card number has a six digit BIN (e.g., 622119 for a closed loop card), a one digit PRIN, an eight digit randomly generated sequence number, and a one digit check sum. This card number is uniquely associated with the card serial number, which may be printed on the hack of the card in a scratch-off area.

The card can be activated and linked in various ways, including through the web, via mobile, or via TYR (Interactive Voice Response). For activation via the web, the user first accesses a site of the payment provider, which may be printed on the card. The user may then log in, if not already logged in, such as by entering a password or PIN and a user identifier if needed. The user then enters the serial number of the card. The payment provider looks up the card number from the serial number and links the card to the user's account. The user is then notified of a confirmation.

For a mobile activation, the user first launches an app of the payment provider from the user mobile device and logs in, such by the mobile phone number and PIN. Once authenticated, the user can select an option of activating the card. The user may be prompted to enter the serial number of the card printed on the card. The card number is looked up based on the serial number, and the card is linked to the user's account. The user is then notified of a confirmation.

For activation via IVR, the user first calls a number, such as one of the payment provider shown on the card. The user may be asked to provide authenticating information, such as a mobile number, a PIN, a credit card number, a debit card number, a social security number, a date of birth, or some combination of the above. Once an account of the user is found, the user may be voice-prompted to select an option to activate the card. Once selected, such as by with a button push or voice instruction, the user enters or says the serial number on the card. The card number associated with the serial number is then located and linked to the user account. While on the call, the system may also ask the user whether the user wishes to activate a mobile number plus PIN payment option, which is described herein. If so, the user may enter/select a PIN, and the information is processed accordingly.

FIG. 1B is a flowchart showing a process 150 for using a phone plus PIN payment option, as set up in FIG. 1A, at a merchant POS according to one embodiment. At step 152, the user begins the checkout process. For example, after the user has finished shopping, the user typically goes to a cash register or cashier to pay for the items. The items may be scanned at the cash register (e.g., a POS or point of sale). Additional items or services may also be added at the POS. It is at this stage that the user typically presents the cashier with a payment card. The POS may be a cash register or other checkout device at a physical merchant or seller location, such as a store.

However, in this embodiment of the invention, the user does not need to present any physical card or payment instrument to the cashier at the POS. In this embodiment, the user makes the payment through a PIN or key pad at the POS. When the user is ready to start the payment process, which can be before the first item is scanned, after the first item is scanned and before the last item is scanned, or after the last item is scanned, the user selects a payment option with the payment provider or a payment option using a phone number plus PIN. This can be simply selecting the appropriate button on the PIN pad.

The user may then be presented with a screen or field requesting the user to enter the user's phone number (or other identifier), such as through the PIN pad. The user then enters the phone number at step 154. In other embodiments, the user identifier may be entered in different ways, such as through an NFC communication between the user's device and the merchant device. Next, the user may be asked to enter the user's PIN or password, such as by selecting the appropriate numbers/keys on the PIN pad. This can be on the same screen as the phone number entry (at step 154) or on a different screen (at a different step). In other words, the phone number and PIN can be entered together or on different screens.

At step 156, the PIN is encrypted within the PIN pad. Encryption can be done at the hardware or software layer. In another embodiment, the phone number (and/or other data in the payload) is also encrypted. In a further embodiment, the PIN is not encrypted. Encryption provides additional security before the PIN is communicated. However, the cost is a more complicated and/or expensive PIN pad, along with subsequent processing to decrypt the encrypted transmission.

The user phone number and PIN (encrypted PIN in this embodiment) are then communicated to the payment provider at step 158. In one embodiment, the phone number and PIN are transmitted from the PIN pad to the cash register to a backend merchant server, where the merchant server then transmits the phone number and PIN, along with merchant information, to the payment provider. Merchant information may include an identifier that identifies the merchant to the payment provider. The merchant may have an account with the payment provider, which allows the payment provider to access the merchant's account through the merchant identifier. If the merchant does not have an account, the merchant may create an account or include information about a merchant account with a third party, such that the payment provider may deposit funds into the merchant account if payment for the transaction is approved. Merchant information may include the location of the merchant as well. The merchant server may call one or more checkout APIs of the payment provider for communicating this information.

In another embodiment, the user may be authenticated by swiping a card, such as one with a magnetic strip, or having a card scanned, such as one with a QR or bar code, at the POS. The user has a card issued by the payment provider. The user may swipe the card or have the card scanned at the POS to authenticate the user and obtain access to the user's account. In this embodiment, the card swipe or scan is equivalent in terms of result to the phone number plus PIN. In other words, the card swipe can be an identity token to authenticate the user.

In another embodiment, the card is swiped to communicate an account identifier. The user would still need to enter a valid PIN to access the account for use with the current payment transaction. Thus, the card acts, in this embodiment, as the phone number described above. All other processing remains the same, unless any simple modifications need to be made based on the different ways the user presents the account identifier (through entry of a mobile number or through a card swipe).

Once the payment provider has received information from the merchant, the payment provider accesses the user's account using the information received. In one embodiment, the payment provider searches for accounts associated with the received user phone number. If no corresponding valid account exists, the merchant and/or the user may be informed accordingly. The user may have entered an incorrect number. If that is the case, the user may re-enter the user's phone number or re-swipe the user's card. Alternatively, the user may have entered a correct number, but there is no account associated with the number or the account has been closed. The user may be notified to take an appropriate action, such as opening an account, providing any outdated information, etc.

The payment provider also determines whether the received PIN is the correct one that is associated with the user's account. If the PIN is encrypted, the payment provider may decrypt the PIN first. If the PIN does not match the PIN associated with the user's account, the user may be asked, such as through the merchant, to reenter the PIN.

When the user's account is verified and can be used with the transaction (e.g., no restrictions on this merchant, the number of transactions has not been exceeded, etc.), the payment provider may generate a key or token. Also, based on information from the user's account and received merchant information, the payment processor determines any coupons, incentives, loyalty points, or other value items the user can use with the merchant. For example, the merchant may have a general coupon or discount available for that store and that day, the user may have certain coupons or points that can be applied to the merchant, or the merchant may have offers specific for the user. At step 162, the payment provider transmits any discounts, incentives, or value items, along with the key or token, to the merchant, such as the merchant server, which may then pass the information to the cash register and to the PIN pad if needed.

If the items are still being scanned or input into the merchant system, any discounts may be applied as they are received or the discounts may be applied when the items have all been scanned. If the items have already been scanned, any discounts may be applied immediately. Regardless, once the items have been scanned and any discounts applied, at step 164, the total is updated (if discounts are applied after the initial scan) or a total is obtained (factoring in any discounts applied during the scanning).

Next, the payment provider transmits, at step 166, the transaction details and the earlier received key or token to the payment provider. This may be through another API call from the merchant. The transaction details may include individual item information, such as item descriptions and amounts, a total amount, and any discounts applied and how the discounts were applied, (e.g., generally or to specific items).

The payment provider then processes the information to determine whether the payment is approved or denied. A denial may result from certain conditions of the user's account not being met or restrictions/limitations being met. For example, the total amount may be above what the account allows. Certain items may also be prohibited for purchase using the user's account.

As such, once a determination is made, the merchant is notified, at step 168, such as through the merchant server, which may then pass the notification to the cash register and PIN pad if needed. Notification may include an approve or deny message, along with a transaction identification associated with the transaction. If a deny message is received, the merchant may request the user provide another form or source of payment.

However, if the payment is approved, the transaction may be concluded, with the user receiving the purchased goods. A receipt may be created and electronically stored. The user may receive a conventional paper receipt and/or a digital receipt sent to the user's mobile device. The user may also be notified of the approved payment or a payment denial, such as through the user's mobile device.

Note that not all steps are required above and one or more steps can be omitted, performed in a different order, or combined if suitable. For example, the key or token may not need to be generated, and offers and other value items may not need to be transmitted to the merchant. Also, the PIN can be communicated to the payment provider at any time during the transaction, including after any coupons and other incentives are transmitted to the merchant. In one embodiment, the user simply enters a phone number and PIN into a merchant device, the payment provider receives this information, along with transaction information, which may include merchant details, and makes a determination whether to approve the transaction based on the received information.

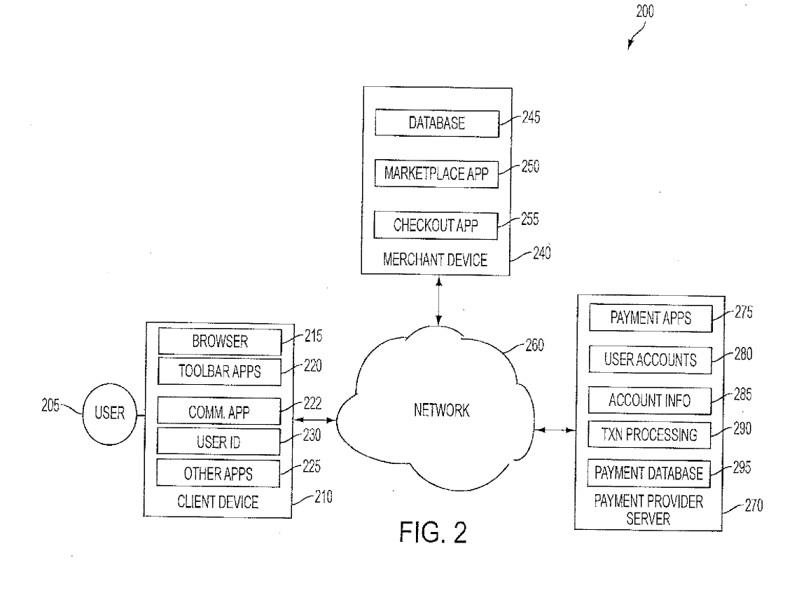

FIG. 2 is a block diagram of a networked system 200 configured to handle a financial transaction between a payment recipient (e.g., merchant) and a payment sender (e.g., user or consumer) at a POS, such as described above, in accordance with an embodiment of the invention. System 200 includes a user device 210, a merchant server 240, and a payment provider server 270 in communication over a network 260. Payment provider server 270 may be maintained by a payment provider, such as PayPal, Inc. of San Jose, Calif. A user 205, such as the sender or consumer, is associated with user device 210, where the user performs a payment transaction with merchant server 240 using payment provider server 270.

User device 210, merchant server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet. User device 210 may also include one or more toolbar applications 220 which may be used, for example, to provide client-side processing for performing desired tasks in response to operations selected by user 205. In one embodiment, toolbar application 220 may display a user interface in connection with browser application 215 as further described herein.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, and texts through network 260, as well as applications that enable the user to communicate, place orders, and make payments through the payment provider as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 210 to communicate within system 200.

Merchant server 240 may be in communication with a PIN pad and/or a cash register for entry and transmission of the user's phone number and PIN, as discussed above, both of which are not shown here. Merchant server 240 may be maintained, for example, by a merchant or seller offering various products and/or services in exchange for payment to be received over network 260. Generally, merchant server 240 may be maintained by anyone or any entity that receives money, which includes charities as well as retailers and restaurants. Merchant server 240 includes a database 245 identifying available products and/or services (e.g., collectively referred to as items) which may be made available for viewing and purchase by user 205, including receipts associated with identifiers, such as barcodes. Accordingly, merchant server 240 also includes a marketplace application 250 which may be configured to serve information over network 260 to browser 215 of user device 210. In one embodiment, user 205 may interact with marketplace application 250 through browser applications over network 260 in order to view various products, food items, or services identified in database 245.

Merchant server 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation from payment service provider server 270, as well as transmit transaction information to the payment provider and receive information from the payment provider. Checkout application 255 may also be configured to accept one or more different funding sources for payment, as well as create an invoice or receipt of the transaction.

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and/or merchant server 240 over network 260 to facilitate the purchase of goods or services by user 205 of user device 210 at a merchant POS or site as discussed above.

Payment provider server 270 also maintains a plurality of user accounts 280, each of which may include account information 285 associated with individual users. For example, account information 285 may include private financial information of users of devices such as account numbers, passwords, device identifiers, user names, phone numbers, credit card information, bank information, PINs/passwords, coupons, discounts, incentives, loyalty points, value items, or other financial information which may be used to facilitate online transactions by user 205. Merchant details may also be stored within account information 285 or another part of payment provider server 270. Advantageously, payment application 275 may be configured to interact with merchant server 240 on behalf of user 205 during a transaction with checkout application 255 to track and manage purchases made by users and which funding sources are used.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order and payment at a merchant POS as described herein. As such, transaction processing application 290 may store details of an order associated with transaction between a merchant and user. Payment application 275 may be further configured to determine the existence of and to manage accounts for user 205, as well as create new accounts if necessary.

Payment database 295 may store transaction details from completed transactions, including authorization details and/or details of the transaction. Such information may also be stored in a third party database accessible by the payment provider and/or the merchant.

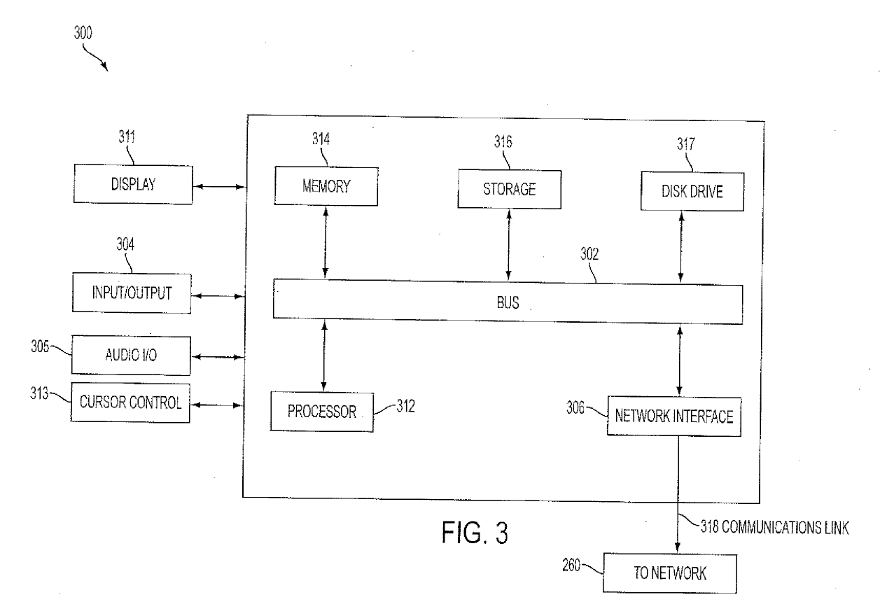

FIG. 3 is a block diagram of a computer system 300 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing user account information, wherein the information comprises an account identifier and a PIN for a user; and
one or more processors for
receiving a user identifier from the user at the POS;
receiving a PIN or password entered by the user at the POS;
receiving information about a merchant at the POS;
accessing an account of the user with the payment provider;
communicating, to the merchant, any value items for the financial transaction;
receiving information about the transaction, including a total amount; and
notifying the merchant whether to approve the total amount for the transaction.

2. The system of claim 1, wherein the PIN or password is encrypted before transmission to the payment provider.

3. The system of claim 2, wherein the PIN or password is entered into a PIN pad at the POS and encryption is done inside the PIN pad.

4. The system of claim 1, wherein the one or more processors further communicates, to the merchant, a key associated with the financial transaction and the user.

5. The system of claim 4, wherein the one or more processors further receives the key from the merchant.

6. The system of claim 1, wherein the one or more processors further notifies the user through a user device whether to approve the total amount for the transaction.

7. The system of claim 1, wherein value items comprises at least one of loyalty points, discounts, and coupons.

8. The system of claim 1, wherein the user identifier is a mobile number of the user.

9. The system of claim 1, wherein the user identifier is received through a card swiped at the POS.

10. The system of claim 9, wherein the user identifier is contained only on a magnetic strip on the card.

11. A method of processing a financial transaction at a point of sale (POS), comprising:
receiving, electronically by a hardware processor of a payment provider, a user identifier from the user at the POS;
receiving, by the processor, a PIN or password entered by the user at the POS;
receiving information about a merchant at the POS;
accessing an account of the user with the payment provider;
communicating, electronically to the merchant, any value items for the financial transaction;
receiving information about the transaction, including a total amount; and
notifying the merchant whether to approve the total amount for the transaction.

12. The method of claim 11, wherein the PIN or password is entered into a PIN pad at the POS and the PIN or password is encrypted inside the PIN pad.

13. The method of claim 11, wherein value items comprises at least one of loyalty points, discounts, and coupons.

14. The method of claim 11, wherein the user identifier is a mobile number of the user.

15. The method of claim 11, wherein the user identifier is received through a card swiped at the POS.

16. The method of claim 15, wherein the user identifier is contained only on a magnetic strip on the card.

17. A non-transitory machine-readable medium comprising a plurality of machine-readable instructions which when executed by one or more processors of a server are adapted to cause the server to perform a method comprising:
receiving, by payment provider, a user identifier from the user at the POS;
receiving a PIN or password entered by the user at the POS;
receiving information about a merchant at the POS;
accessing an account of the user with the payment provider;
communicating, to the merchant, any value items for the financial transaction;
receiving information about the transaction, including a total amount; and
notifying the merchant whether to approve the total amount for the transaction.

18. The non-transitory machine-readable medium of claim 17, wherein the PIN or password is entered into a PIN pad at the PIN or password is encrypted inside the PIN pad.

19. The non-transitory machine-readable medium of claim 17, wherein value items comprises at least one of loyalty points, discounts, and coupons.

20. The non-transitory machine-readable medium of claim 17, wherein the user identifier is a mobile number of the user.

21. The non-transitory machine-readable medium of claim 17, wherein the user identifier is received through a card swiped at the POS.

22. The non-transitory machine-readable medium of claim 21, wherein the user identifier is contained only on a magnetic strip on the card.
